(19) United States
(12) Patent Application Publication
(10) Pub. No.: US 2008/0252604 A1
(43) Pub. Date: Oct. 16, 2008

(54) OSD controlling system and operation method thereof

(75) Inventors: Che-Min Huang, Miao-Li (TW); Chien-Tung Chu, Miao-Li (TW); Chi-Wen Chiang, Miao-Li (TW); Hsiao-Ching Hung, Miao-Li (TW); Hsiao-Yuan Ho, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/082,786

(22) Filed: Apr. 14, 2008

(30) Foreign Application Priority Data
Apr. 13, 2007 (CN) 200710074022.2

(51) Int. Cl. G09G 5/00; G06F 3/048

(52) U.S. Cl. 345/172; 715/772

(57) ABSTRACT

An exemplary on-screen display (OSD) controlling system (20) for a display device is provided. The system includes OSD buttons (22) without any symbols and an OSD menu (25) configured for displaying and adjusting characteristics of the display device. The OSD menu includes a primary OSD menu (211) and OSD submenus (213). The primary OSD menu displays first function icons (2112, 2113, 2114, 2115) denoting the display characteristics. Each function icon corresponds to at least one OSD submenu. Each OSD submenu includes second function icons (2141, 2142, 2143, 2144, 2145) configured to denote functions or movements of the corresponding OSD buttons. Each function icon of each OSD submenu corresponds to one OSD button.

### BACKGROUND

1. Field of the Invention

The present invention relates to an on-screen display (OSD) controlling system and an OSD operation method.

2. General Background

In general, a monitor is a display device that is used with an apparatus such as a computer in order to show data generated by the computer. Most popular monitors can be classified as either CRT (Cathode Ray Tube) monitors or LCD (Liquid Crystal Display) monitors.

Some such monitors have an OSD function for displaying information relating to adjusting of display characteristics of video signal transmitted from the computer as well as information about the monitor itself. The OSD activated on the screen of the monitor can include a plurality of menus for altering information associated with a shape, a color, etc., of the display, or can include information about the video signals.

Referring to FIG. 10, this is a block diagram of a conventional OSD controlling system 10 used in a display device. The OSD controlling system 10 includes a display screen 12, a plurality of OSD buttons 14, a control circuit board 16, a printed circuit board (PCB) 18, and an OSD menu 19.

The OSD menu 19 is a rectangular window interface, and can display icons and characters associated with parameter values of the display characteristics. For example, the icon “¤” relates to the brightness of the display screen 12. When the icon “¤” is focused, a parameter value of the current brightness is displayed in the window interface. The display screen 12 is configured to display the OSD menu 19 and other images and videos. The OSD buttons 14 are formed at an outer frame of the display device. Corresponding symbols are printed or notched at the outer frame adjacent to the OSD buttons 14, such that functions of the OSD buttons 14 can be recognized by users. Generally, the OSD buttons 14 include a primary menu button 141, an increment button 142, and a decrement button 143 which correspond to symbols “Menu”, “+”, and “−” respectively. The control circuit board 16 is configured to sense movements of the OSD buttons 14, and sends corresponding signals to the PCB 18. The PCB 18 is configured to call and process OSD resources according to the signals from the control circuit board 16, so as to constitute the OSD menu 19 on the display screen 12. The OSD resources include a character library, a window graphics library, a function program segment, and an action program segment. The character library is configured to set letters and numbers of the OSD menu 19. The window graphics library is configured to set function icons of the OSD menu 19. The function program segment is configured to set adjustable display characteristics, such as a color temperature, a brightness, a contrast ratio, and so on. The action program segment is configured to set the relationship between the adjustable display characteristics of the OSD menu 19.

An operation method of the OSD controlling system 10 includes the following steps:

Step S11: a user presses the primary menu button 141. The control circuit board 16 senses this action, and sends a corresponding signal to the PCB 18. The PCB 18 calls corresponding OSD resources, processes the OSD resources, and then transfers the OSD resources to the display screen 12. Thereby, the OSD menu 19 is displayed on the display screen 12. At the same time, a cursor appears on the display screen 12, pointing at one of the function icons of the OSD menu 19.

Step S12: the user presses the increment button 142 or the decrement button 143 to move the cursor to point at a desired function icon, and presses the primary menu button 141 to select the desired function icon. The control circuit board 16 senses this action, and sends a corresponding signal to the PCB 18. The PCB 18 calls corresponding OSD resources, processes the OSD resources, and then transfers the OSD resources to the display screen 12. Thereby a current parameter value of a corresponding display characteristic is displayed on the display screen 12.

Step S13: the user presses the increment button 142 or the decrement button 143 to increase or decrease the current parameter value so as to adjust a the corresponding display characteristic of the display device.

Step S14: the user exits the OSD menu 19.

As described above, the user needs to repeatedly press the increment button 142 or the decrement button 143 to move the cursor to choose the desired function icon. Thus the operation method of the OSD controlling system 10 is complicated and inconvenient.

What is needed, therefore, is a new OSD controlling system that can overcome the above-described deficiencies. What is also needed is an OSD operation method employing the OSD controlling system.

### SUMMARY

In one preferred embodiment, an OSD controlling system includes a plurality of OSD buttons and an OSD menu. The OSD buttons are configured to provide an inputting channel between the display device and a user. The OSD menu is configured for displaying and adjusting display characteristics of the display device and includes a plurality of OSD submenus and a primary OSD menu. The primary OSD menu is configured to display first function icons denoting the display characteristics. Each of the first function icons corresponds to at least one OSD submenu that is configured to adjust and set a parameter value of the corresponding display characteristic. Each OSD submenu includes at least one second function icons. The at least one second function icon of each OSD submenu corresponds to at least one OSD button, and the at least one second function icon is configured to denote functions or movements of the corresponding OSD buttons.

Other advantages and novel features will become more apparent from the following detailed description when taken in conjunction with the accompanying drawings.

### BRIEF DESCRIPTION OF THE DRAWINGS

FIG. 1 is an abbreviated, block diagram of an OSD controlling system according to an exemplary embodiment of the present invention, the OSD controlling system including an OSD menu.

FIG. 2 is a block diagram of the OSD menu of FIG. 1, the OSD menu including a primary OSD menu and a plurality of OSD submenus.

FIG. 3 is a front view of a display device employing the OSD controlling system of FIG. 1, illustrating the primary OSD menu being displayed on a display screen, the primary OSD menu including an auto-adjustment icon, a color enhancement icon, an audio controlling icon and a primary menu icon, the auto-adjustment icon, the color enhancement icon and the audio controlling icon being configured as shortcut icons.

FIG. 4 illustrates an auto-adjustment OSD submenu corresponding to the auto-adjustment icon of the primary OSD menu of FIG. 3 being displayed on a display screen.

FIG. 5 illustrates a color enhancement OSD submenu corresponding to the color enhancement icon of the primary OSD menu of FIG. 3 being displayed on a display screen.

FIG. 6 illustrates an audio controlling OSD submenu corresponding to the audio controlling icon of the primary OSD menu of FIG. 3 being displayed on the display screen.

FIG. 7 illustrates brightness adjusting OSD submenus related to a brightness of the display screen.

FIG. 8 is a flow chart of an operation method utilizing the shortcut icons of the OSD controlling system of FIG. 3.

FIG. 9 is a flow chart of an operation method utilizing the primary menu icon of the OSD controlling system of FIG. 3.

FIG. 10 is a block diagram of a conventional OSD controlling system.

### DETAILED DESCRIPTION OF PREFERRED EMBODIMENTS

Referring to FIG. 1, an OSD controlling system 20 for a display device according to an exemplary embodiment of the present invention is shown. The OSD controlling system 20 includes a display screen 21, a plurality of OSD buttons 22, a control circuit board 23, a PCB 24 and an OSD menu 25.

The OSD buttons 22 are formed at an outer frame of the display device without any symbols. The display screen 21 is configured to display the OSD menu 25 and other images and videos. The control circuit board 23 is configured to sense movements of the OSD buttons 22, and sends corresponding signals to the PCB 24. The PCB 24 is configured to call and process OSD resources stored therein according to the signals transmitted from the control circuit board 23, so as to constitute the OSD menu 25 on the display screen 21.

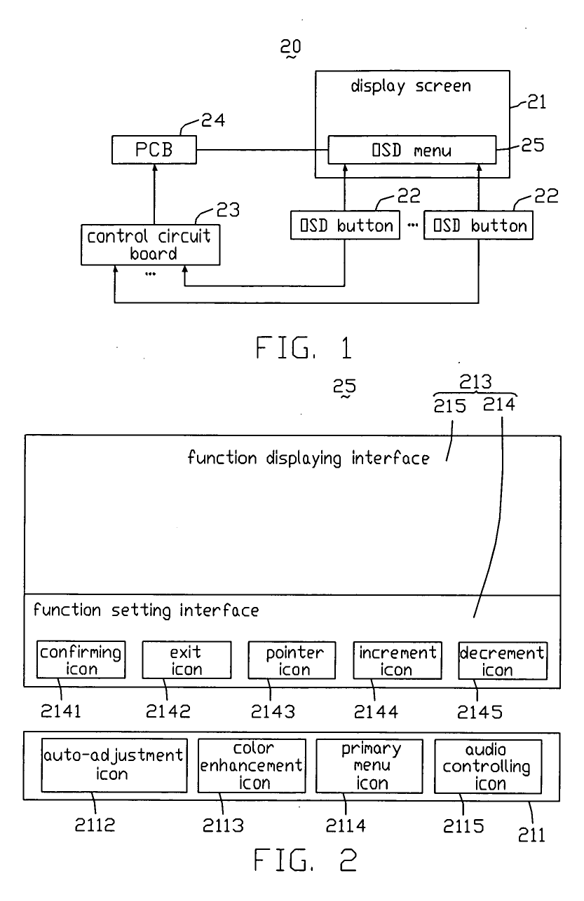

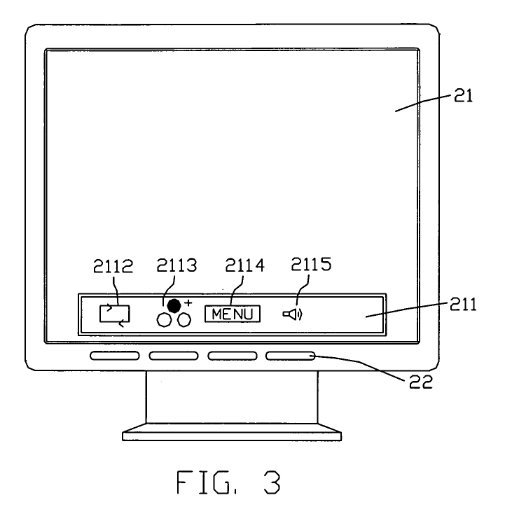

Referring to FIG. 2, a block diagram of the OSD menu 25 is shown. The OSD menu 25 includes an OSD primary menu 211 and a plurality of OSD submenus 213 (only one is shown). Referring also to FIG. 3, the OSD primary menu 211 is displayed on the display screen 21 of the display device.

The OSD primary menu 211 is a rectangular window interface, and can display an auto-adjustment icon 2112, a color enhancement icon 2113, a primary menu icon 2114, and an audio controlling icon 2115 alternately aligned in a line. The auto-adjustment icon 2112, the color enhancement icon 2113 and the audio controlling icon 2115 as shortcut icons respectively denote corresponding display characteristics. For example, the audio controlling icon 2115 marked as a bugle shape relates to an audio volume of the display screen 21. The primary menu icon 2114 marked as a symbol “MENU” relates to other display characteristics, for example a brightness, a color temperature, a language and a contrast ratio etc., of the display screen 21.

Each OSD submenu 213 includes a function setting interface 214 and a function displaying interface 215. The function displaying interface 215 can display graphic icons and characters associated with current parameter values of the display characteristics. The function setting interface 214 includes a function icon assembly that is selected from the group consisting of a confirming icon 2141, an exit icon 2142, at least one pointer icon 2143, an increment icon 2144, and a decrement icon 2145. The confirming icon 2141 corresponding to a symbol “OK” is configured to select and enter a current displaying OSD submenu. The exit icon 2142 corresponding to a symbol “←” is configured to exit the current OSD submenu. The at least one pointer icon 2143 corresponding to a symbol “>” or “<” is configured to shift the current displaying OSD submenu between the OSD submenus 213. The increment icon 2144 and the decrement icon 2145 corresponding to symbols “+” and “−” are configured to adjust a parameter value of the current display characteristic.

Four OSD buttons 22 are located in an outer frame 53 surrounding the display screen 21, and respectively corresponds to the auto-adjustment icon 2112, the color enhancement icon 2113, the primary menu icon 2114, and the audio controlling icon 2115. When the OSD button 22 corresponding to one of the shortcut icons or the primary menu icon 2114 is pressed, a corresponding OSD submenu 213 is displayed on the display screen 21 instead of the OSD primary menu 211. At the same time, the function icons of the function setting interface 214 respectively correspond to the OSD buttons 22. The number of the OSD buttons 22 is calculated according to the formula: y≧max{(n+1), m}, wherein y is the number of the OSD buttons 22, n is the number of the shortcut icons, and m is a maximum value of the number of the function icons of the OSD submenus 213.

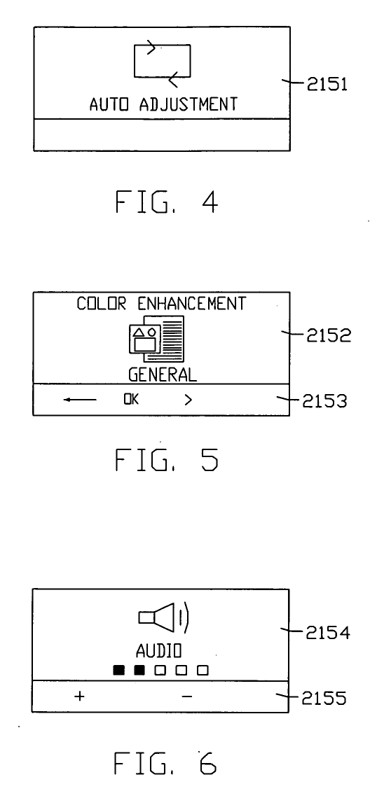

Referring to FIG. 4, the auto-adjustment icon 2112 corresponds to an auto adjustment OSD submenu including a first function displaying interface 2151. A character “AUTO ADJUSTMENT” and a corresponding graphic icon are displayed in the first function displaying interface 2151. When the OSD button 22 corresponding to the auto-adjustment icon 2112 is pressed, the auto-adjustment OSD submenu is displayed on the screen 21 instead of the OSD primary menu 211.

Referring to FIG. 5, the color enhancement icon 2113 corresponds to a group of color enhancement OSD submenus that are related to display modes of the display screen 21. The display modes include a general mode, a graphic mode, a text mode, a game mode and a movie mode. Different display modes are coupled with different display characteristics. Each color enhancement OSD submenu includes a second function displaying interface 2152 and a second function setting interface 2153. The second function display interface 2152 can display graphic icons denoting various display modes and characters. The second function setting interface 2153 is configured to shift the current displaying OSD submenu between the group of the color enhancement OSD submenus and confirm one of the color enhancement OSD submenus as a target OSD submenu, thereby the display screen 21 works in a corresponding display mode.

When the OSD button 22 corresponding to the color enhancement icon 2113 is pressed, the OSD menu 25 displayed on the display screen 21 is shifted from the OSD primary menu 211 to a default color enhancement OSD submenu, for example an OSD submenu corresponding to the general mode. Characters “COLOR ENHANCEMENT” and “GENERAL” and a corresponding graphic icon are displayed in the second function displaying interface 2152. An exit icon 2142, a confirming icon 2111, and a pointer icon 2143 are displayed in the second function setting interface 2153 in sequence, and correspond to three of the OSD buttons 22. When the OSD button 22 corresponding to the pointer icon 2143 is pressed at a time, the OSD menu 25 displays on the display screen 21 is shifted from the default color enhancement OSD submenu to a next color enhancement OSD submenu in a predetermined order.

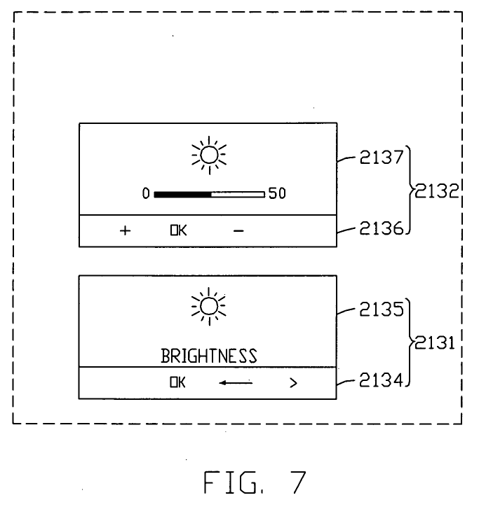

Referring to FIG. 6, the audio controlling icon 2115 corresponds to an audio OSD submenu including a third function displaying interface 2154 and a third function setting interface 2155. A character “AUDIO”, a current parameter value, and a corresponding graphic icon are displayed in the third function displaying interface 2154. An increment icon 2144 and a decrement icon 2145 are displayed in the third function setting interface 2155, and correspond to two of the OSD buttons 22. When the OSD button 22 corresponding to the audio controlling icon 2115 is pressed, the OSD menu 25 displayed on the display screen 21 is shifted from the OSD primary menu 211 to the audio OSD submenu.

Referring to FIG. 7, brightness adjusting OSD submenus related to a brightness of the display screen 21 is shown. In this described embodiment, a plurality of OSD submenus 213 corresponding to the primary menu icon 2114 are configured to set or adjust a brightness, a contrast ratio, a color temperature, a language, a system function and a recall function of the display screen 21 in sequence. The system function includes following functions: a clock setting, a phase setting, a power supply operation modes setting, an H-position adjusting and a V-position adjusting. The recall function is configured to recall an original displaying state of the display screen 21.

When the OSD button 22 corresponding to the primary menu icon 2114 is pressed, a default OSD submenu related to one of the above described display characteristics, for example a first level brightness OSD submenu 2131, is displayed on the display screen 21 instead of the primary OSD submenu 211. The first level brightness OSD submenu 2131 includes a fourth function setting interface 2134 and a fourth function displaying interface 2135. A character “BRIGHTNESS” and a corresponding graphic icon “¤” are displayed in the fourth function displaying interface 2135. A confirming icon 2141, an exit icon 2142 and a pointer icon 2143 are displayed in the fourth function setting interface 2134 and correspond to three of the OSD buttons 22. When the OSD button 22 corresponding to the pointer icon 2143 is pressed at a time, the default OSD submenu shifts to a next OSD submenu 213 related to another display characteristic. When the OSD button 22 corresponding to the confirming icon 2141 is pressed, the OSD menu 25 is shifted from the first brightness OSD submenu 2131 to a second level brightness OSD submenu 2132. The second level brightness OSD submenu 2132 includes a fifth function setting interface 2136 and a fifth function displaying interface 2137. A level meter, a character “50” and the graphic icon “¤” are displayed in the fifth function displaying interface 2137. The level meter is a rectangular form disposed under the graphic icon. The variable or moving indicator of the level meter is represented in the form of a moving bar depending upon the display characteristic. The character “50” denotes a current parameter value of the brightness of the display screen 21. An increment icon 2144, a decrement icon 2145, and a confirming icon 2141 are displayed in the fifth function setting interface 2136 and correspond to three of the OSD buttons 22.

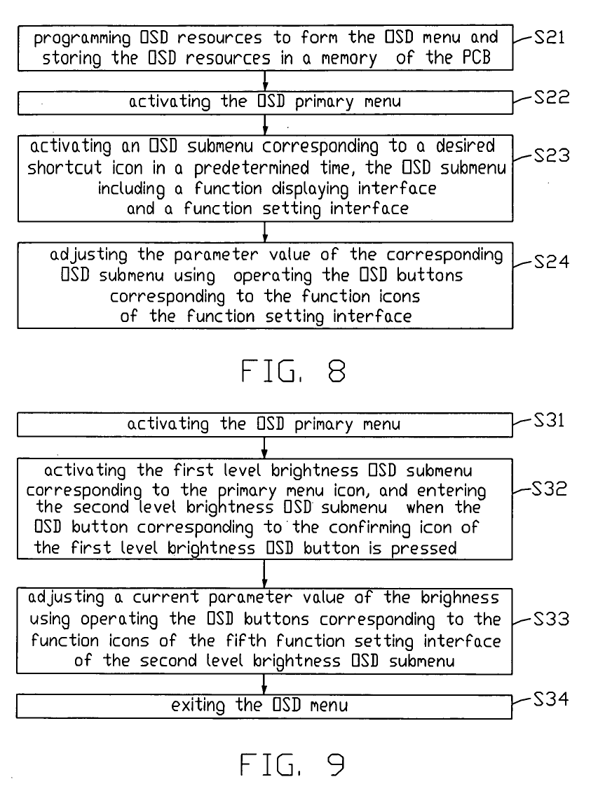

Referring to FIG. 8, an exemplary OSD operation method utilizing shortcut icons of the OSD controlling system 20 includes the following steps:

Step S21: programming OSD resources to form the OSD menu 25 and storing the OSD resources in a memory of the PCB 24.

Step S22: activating the OSD primary menu 211. When a user presses one of the OSD buttons 22, the control circuit board 23 senses this action, and sends a corresponding signal to the PCB 24. The PCB 24 calls corresponding OSD resources, processes the OSD resources, and transfers the OSD resources to the display screen 21, thereby the OSD primary menu 211 is activated and displayed on the display screen 21.

Step S23: activating an OSD submenu 213 corresponding to a desired shortcut icon in a predetermined time, the OSD submenu 213 including a function displaying interface 215 and a function setting interface 214. After entering the OSD primary menu 211, the control circuit board 23 senses whether the OSD buttons 22 are pressed in the predetermined time. If the OSD buttons 22 are not pressed, no OSD resources are transferred to the display screen 21, thereby the display screen 21 exits displaying the OSD menu 25. If the OSD button 22 corresponding to the desired shortcut icon is pressed in the predetermined time, a corresponding OSD submenu 213 is activated and displayed on the display screen 21 instead of the OSD primary menu 211.

Step S24: adjusting the parameter value of the corresponding OSD submenu 213 using operating the OSD buttons 22 corresponding to the function icons of the function setting interface 214. For example, when the OSD button 22 corresponding to the color enhancement icon 2113 is pressed, a default OSD submenu denoting a current displaying mode is displayed on the display screen 21. The current displaying mode is a text mode. When the OSD button 22 corresponding to the pointer icon 2143 of the second function setting interface 2153 is pressed two times, the current displaying mode is shifted from the text mode to a game mode, and a color enhancement OSD submenu denoting the game mode is displayed on the display screen 21. Then the OSD button 22 corresponding to the confirming icon 2141 is pressed, the current display mode is modified as the game mode, and the display screen 21 automatically stops displaying the color enhancement OSD submenu of the game mode.

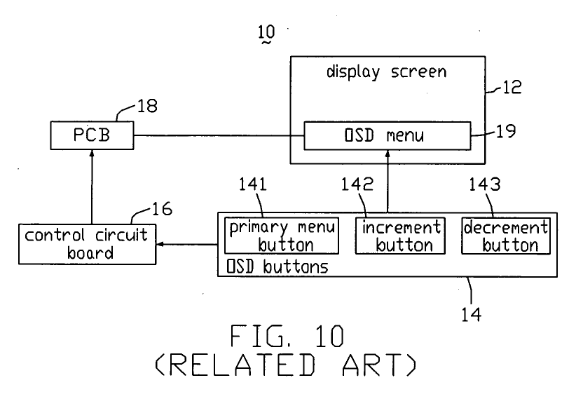

Referring to FIG. 9, an exemplary OSD operation method utilizing the primary menu icon 2114 of the OSD controlling system 20 for adjusting the brightness includes the following steps:

Step S31: activating the OSD primary menu 211.

Step S32: activating the first level brightness OSD submenu 2131 corresponding to the primary menu icon 2114, and entering the second level brightness OSD submenu 2132 when the OSD button 22 corresponding to the confirming icon 2141 of the first level brightness OSD submenu 2131 is pressed. When the OSD button 22 corresponding to the primary menu icon 2114 is pressed in the predetermined time, the first level brightness OSD submenu 2131 serves as the default OSD submenu, and is displayed on the display screen 21 instead of the OSD primary menu 211. Then the confirming icon 2141 is pressed, the control circuit board 23 senses this action, and sends a corresponding signal to the PCB 24. The PCB 24 calls corresponding OSD resources, processes the OSD resources, and transfers the OSD resources to the display screen 21. Thereby the second level brightness OSD submenu 2132 is displayed on the display screen 21.

Step S33: adjusting a current parameter value of the brightness using operating the OSD buttons 22 corresponding to the function icons of the fifth function setting interface 2136 of the second level brightness OSD submenu 2132. After entering the second level brightness OSD submenu 2132, the parameter value of the brightness can be adjusted by pressing a selected one of the OSD buttons 22 corresponding to the increment icon 2144 and the decrement icon 2145. At the same time, the brightness of the display screen 21 is correspondingly changed following movements of the OSD buttons 22.

Step S34: exiting the OSD menu 25. When a proper parameter value of the brightness is set, the OSD button 22 corresponding to the confirming icon 2141 of the fifth function setting interface 2136 is pressed. The display screen 21 automatically stops displaying the OSD menu 25 and displays other images with desired.

In summary, the OSD menu 25 includes icons of the primary OSD menu 211 or the function setting interface 214 of each OSD submenu 213 that are respectively correspond to the OSD buttons 22. It means that each OSD button 22 has a special function corresponding to a respective function icon when the primary OSD menu 211 or one of the OSD submenus 212 is displayed. At the same time, each OSD button 22 can changes its function following shifts between two OSD submenus 213 or between the primary OSD menu 211 and one of the OSD submenu 213. Thus, users can spend less time to select a desired icon. This results in convenient operation and high efficiency.

In addition, because the OSD menu 25 includes three shortcut icons related to three display characteristics, the operation method for adjusting the three display characteristics is more convenient.

In an alternative embodiment, the OSD controlling system 20 can add an additional shortcut icon and a corresponding OSD button 22 according to requirements of the users.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An on-screen display (OSD) controlling system for a display device, the OSD controlling system comprising:
a plurality of OSD buttons configured for providing an inputting channel between the display device and a user; and
an OSD menu configured for displaying and adjusting display characteristics of the display device, the OSD menu comprising a plurality of OSD submenus and a primary OSD menu that is configured for displaying first function icons denoting the display characteristics, each of the first function icons corresponding to at least one OSD submenu that is configured for adjusting and setting a parameter value of the corresponding display characteristic, each OSD submenu comprising at least one second function icon;
wherein the at least one second function icon of each OSD submenu corresponds to at least one OSD button, and the at least one second function icon is configured for denoting functions or movements of the corresponding OSD buttons.

2. The OSD controlling system as claimed in claim 1, wherein the first function icons comprises a primary menu icon and at least one shortcut icon, the at least one shortcut icon denotes one of the display characteristics and is configured for activating a corresponding OSD submenu, the primary menu icon denotes other display characteristics except the display characteristics coupled with the at least one shortcut icon and is configured for activating corresponding OSD submenus.

3. The OSD controlling system as claimed in claim 2, wherein the primary menu icon and the at least one shortcut icon alternatively aligned in a line respectively correspond to the OSD buttons.

4. The OSD controlling system as claimed in claim 2, wherein the number of the OSD buttons is calculated according to the formula y≧max {(n+1), m}, wherein y is the number of the OSD buttons, n is the number of the at least one shortcut icon, and m is a maximum value of the number of the second function icons of the OSD submenus.

5. The OSD controlling system as claimed in claim 2, wherein the at least one shortcut icon comprises at least one item selected from the group consisting of an auto-adjustment icon, a color enhancement icon, and an audio controlling icon.

6. The OSD controlling system as claimed in claim 2, wherein upon the condition that the OSD button corresponding to the at least one shortcut icon or the primary menu icon is pressed, a corresponding OSD submenu is displayed instead of the primary OSD menu.

7. The OSD controlling system as claimed in claim 1, wherein the function icons are selected from the group consisting of a confirm icon, an exit icon, at least one pointer icon, an increment icon, and a decrement icon.

8. The OSD controlling system as claimed in claim 1, wherein each of the OSD submenus further comprises a function displaying interface configured for displaying graphic icons and characters associated with current display parameter values.

9. The OSD controlling system as claimed in claim 2, further comprising a control circuit board configured for sensing movements of the OSD buttons and outputting corresponding signals.

10. The OSD controlling system as claimed in claim 9, further comprising a printed circuit board configured for calling and process OSD resources stored therein according to the corresponding signals transmitted from the control circuit board so as to constitute corresponding OSD submenus or the primary OSD menu.

11. The OSD controlling system as claimed in claim 1, wherein the display characteristics are selected from the group consisting of brightness, contrast ratio, color temperature, and language.

12. An on-screen display (OSD) operation method using the OSD controlling system as claimed in claim 1, the OSD controlling method comprising:
entering the primary OSD menu by operating a selected one of the OSD buttons;
selecting and entering a target OSD submenu by operating a corresponding OSD button that corresponds to a desired first function icon denoting a pre-adjusted display characteristic; and
adjusting a parameter value of the pre-adjusted display characteristic by operating the OSD buttons corresponding to the at least one second function icon of the target OSD submenu.

13. The OSD operation method as claimed in claim 12, wherein the OSD controlling system further comprises a control circuit board configured for sensing movements of the OSD buttons and outputting corresponding signals.

14. The OSD operation method as claimed in claim 13, wherein the OSD controlling system further comprises a printed circuit board configured for calling and processing OSD resources stored therein according to the corresponding signals transmitted from the control circuit board so as to constitute a corresponding OSD submenu or the primary OSD menu.

15. The OSD operation method as claimed in claim 14, further comprising the control circuit board sensing whether the OSD buttons are operated in a predetermined time after the step of entering the primary OSD menu, and wherein if no OSD button is operated in the predetermined time, the primary OSD menu automatically exits displaying.

16. The OSD operation method as claimed in claim 12, wherein the first function icons comprising a primary menu icon and at least one shortcut icon, each shortcut icon denotes one of the display characteristic and is configured for activating a corresponding OSD submenu, the primary menu icon denotes other display parameters except the display characteristics coupled with the shortcut icons and is configured for activating corresponding OSD submenus.

17. The OSD operation method as claimed in claim 16, wherein the primary menu icon and the at least one shortcut icon respectively correspond to the OSD buttons.

18. The OSD operation method as claimed in claim 16, wherein the number of the OSD buttons is calculated according to the formula y≧max{(n+1), (m)}, wherein y is the number of the OSD buttons, n is the number of the at least one shortcut icon, and m is a maximum value of the number of the second function icons of the OSD submenus.

19. The OSD operation method as claimed in claim 16, wherein the at least one second function icon is at least one item selected from the group consisting of a confirm icon, an exit icon, at least one pointer icon, an increment icon, and a decrement icon.
